(19) United States
(12) Patent Application Publication
(10) Pub. No.: US 2007/0070392 A1
(43) Pub. Date: Mar. 29, 2007

(54) Processing requests for data sinks in a logical printer

(76) Inventors: Karen Lynn Harrison, Niwot, CO (US); Charles David Johnson, Boulder, CO (US)

Correspondence Address: KONRAD RAYNES & VICTOR, LLP.;ATTN: IBM37, 315 SOUTH BEVERLY DRIVE, SUITE 210, BEVERLY HILLS, CA, 90212, US

(21) Appl. No.: 11/228,782

(22) Filed: Sep. 16, 2005

(51) Int. Cl. G06F 3/12

(52) U.S. Cl. 358/1.15; 358/1.13

(57) ABSTRACT

Provided are a method, system, and program for processing requests for data sinks in a logical printer. A request is received to process a print job from one of a plurality of protocol components. A determination is made of one of a plurality of data sinks for the print job and whether the determined data sink is available. A return code is returned to the component initiating the request. A data sink available message is returned to the component initiating the request in response to determining that the determined data sink is available after returning the return code. Additional asynchronous operations are performed before returning the data sink available message.

### BACKGROUND OF THE INVENTION

1. Field of the Invention

The present invention relates to a method, system, and program for processing requests for data sinks in a logical printer.

2. Description of the Related Art

A printer controller contains one or more logical printers, where each logical printer represents a single printer as viewed by an end user. A single logical printer controls either one or more physical print engines. A logical printer, also known as a logical printer domain (LPD), provides software components to process print jobs from different external sources. The logical printer includes one or more Protocol Interface Modules (PIMs) to handle print jobs for different transmission protocols. The logical printer may include a multiplexer or MUX to manage contentious requests from PIMs to have their print jobs processed by interpreters within the logical printer. The MUX may apply rules to determine which PIM to grant access to a data sink, such as an interpreter or spool.

In certain systems, the PIMs and MUX execute on different threads in a single process. The PIMs execute on threads and must obtain a semaphore or lock from the MUX thread before forwarding their print job to a data sink, such as an interpreter or spool. PIM processing is delayed until the PIM receives the semaphore from the MUX.

There is a need in the art for improved techniques for logical printers to manage the flow of print jobs.

### SUMMARY

Provided are a method, system, and program for processing requests for data sinks in a logical printer. A request is received to process a print job from one of a plurality of protocol components. A determination is made of one of a plurality of data sinks for the print job and whether the determined data sink is available. A return code is returned to the component initiating the request. A data sink available message is returned to the component initiating the request in response to determining that the determined data sink is available after returning the return code. Additional asynchronous operations are performed before returning the data sink available message.

### BRIEF DESCRIPTION OF THE DRAWINGS

FIG. 1 illustrates an embodiment of a computing environment.

FIG. 2 illustrates an embodiment of a logical printer.

FIG. 3 illustrates an embodiment of information associating a PIM with a data sink.

FIG. 4 illustrates information on pending print job.

FIG. 5 illustrates an embodiment of operations performed to handle a request for a data sink.

FIG. 6 illustrates an embodiment of operations performed to request a data sink.

FIG. 7 illustrates an embodiment of operations performed by a despooler to despool a print job from a spool.

FIG. 8 illustrates an embodiment of operations performed to select a print job to process when a job has completed with respect to a data sink.

### DETAILED DESCRIPTION

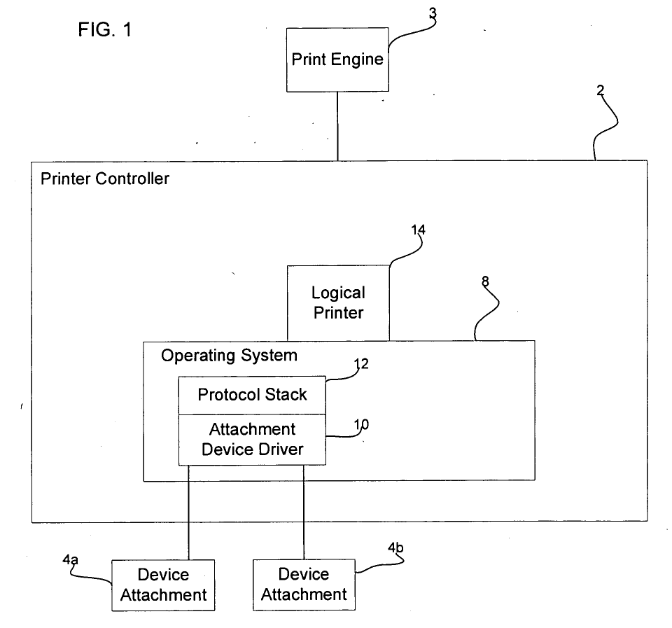

FIG. 1 illustrates a printing computing environment in which embodiments are implemented. A printer controller 2 is in communication with device attachments 4a, 4b from which print jobs are received and a printer engine 3 comprising the physical hardware, laser, etc., that outputs toner on a print media, e.g., paper. The printer controller 2 and printer engine 3 may be in the same printer device or in separate devices and communicate over a direct connection, network connection, etc. The device attachments 4a, 4b may comprise a physical attachment, such as a network attachment, a connection to a host system, such as a mainframe etc. Client systems and applications communicate print jobs to a logical printer 14 through the device attachments 4a, 4b. The printer controller 2 includes an operating system 8 that executes an attachment device driver 10 to communicate with a device and a protocol stack 12 to process network packets for a specific network protocol. The device attachments 4a, 4b receive print jobs and deliver the data associated with print jobs to other components. The protocol stack 12 unpacks print job data from a network message and forward the print job to a logical printer 14. The logical printer 14 consists of a collection of software components that act together to provide the functionality of a printer. The logical printer 14 processes multiple print jobs to control their rasterization and transmission to the print mechanism 6 which forwards data to the print engine 3.

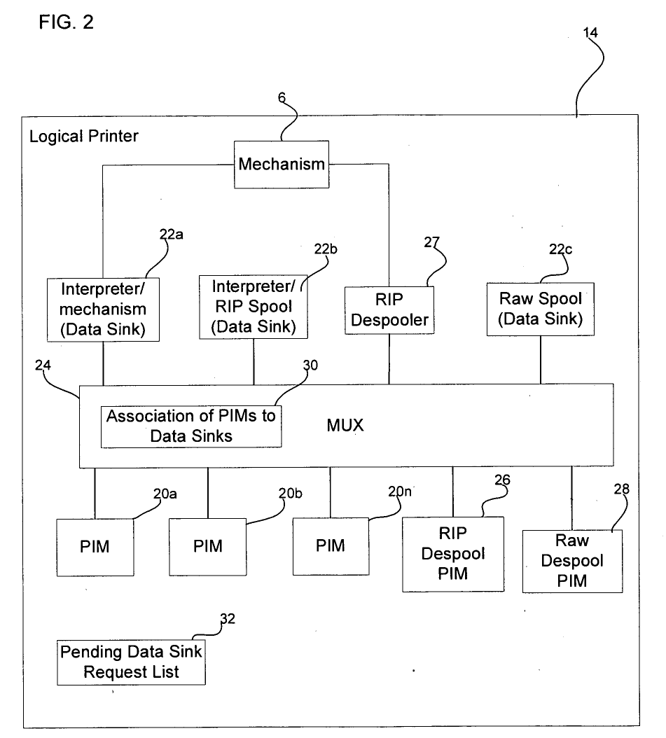

FIG. 2 illustrates an embodiment of a logical printer 14 including various components. A plurality of protocol interface modules (PIMs) 20a, 20b . . . 20n are software components designed to handle communications from a supported protocol, e.g. the Line Printer Daemon Protocol (LPR), File Transfer Protocol (FTP), Parallel channel protocols are each handled by different PIMs. In additional embodiments, components comprising a PIM or other type of component may request a data sink from the MUX 14. A PIM 20a, 20b . . . 20n receives print data from a client system and delivers the print data, free of transmission protocol elements, to a data sink that processes the print job, such as data sinks 22a, 22b, and 22c. Examples of data sinks include a raw spool 22c that spools the print job before the job is sent to an interpreter, an interpreter/RIP spool 22b that spools rasterized print data before the data is sent to the mechanism, and the interpreter/mechanism 22a that performs rasterization of the print job by an interpreter (e.g. Postscript interpreter, an Intelligent Printer Data Stream (IPDS) interpreter, etc.). A PIM 20a, 20b . . . 20n may service multiple concurrent connection requests (receive multiple jobs at once). Other PIMs queue multiple connection requests and process them one at a time.

The PIMs 20a, 20b . . . 20n receive print job data from an external source and deliver the data to an internal data sink 22a, 22b, 22c by calling a Multiplexer (MUX) 24 component. The PIMs 20a, 20b . . . 20n may package incoming data being sent to the MUX 24.

A RIP despool PIM 26 is used to cause the despooling of rasterized print jobs from the interpreter/RIP spool 22b to send to the print mechanism 6. Thus, the data sink for the RIP despool PIM 26 is the print mechanism 6. A raw despool PIM 28 despools print jobs from the raw spool 22c to send to a RIP spool 22b or the interpreter/mechanism 22a. The RIP 22b and raw 22c spools may include the functionality of a despooler, such that their despooler functionality operates as a PIM to despool a queued job. The Raw Despool PIM 28 forwards data to Interpreter/mechanism 22a or Interpreter/RIP Spool 22b. The RIP Despool PIM 26 forwards a request to RIP Despooler 27 that sends to Mechanism 6. In this way, the spools 22b, 22c comprise subsystems that include the capability to spool print jobs in a queue and to despool the print jobs using RIP Despool PIM 26 or Raw Despool PIM 28.

Certain components may function both as a data sink and a PIM. For instance a raw spool component may receive a print job as a data sink to a PIM 20a, 20b . . . 20n, but then a sub component may request a data sink to send spooled data to a downstream component, such as the interpreter/RIP spool 22b or the mechanism 6.

The MUX 24 comprises a software component that is called by the PIMs 20a, 20b. 20n to deliver data to a data sink 22a, 22b, 22c. The MUX determines what data sink will be used for the job, and delivers the data to the selected data sink. In one embodiment, the MUX 24 maintains an association of PIMs to data sinks 30 that associates a data sink 22a, 22b . . . 22n with one or more PIMs. Other parameters of a print job may also be used to determine the data sink in addition to the identity of the PIM, such as the content of the job, and the state of the path to the mechanism and the state of spooling system. For example, certain PIMs 22a, 22b . . . 22n that receive an intelligent printer data stream (IPDS) require that their data be supplied directly to an interpreter/mechanism 22a. Other types of print job content, such as email content, Portable Document Format (PDF) content, etc, are always spooled. If the MUX 14 receives multiple requests for a data sink from different PIMs, then the MUX 14 may use rules and criteria to select a contending request based on the PIM submitting the request and/or parameters of the print job. For instance, some data sinks can only process one job at a time, such as an interpreter/mechanism 22a. Other data sinks may queue jobs. Further, a spool may allow up to a maximum number of jobs to be spooled concurrently. The MUX 24 may consist of library routines that are called by the PIMs 20a, 20b . . . 20n, as well as a separate MUX process that communicates through messages.

The logical printer 14 may further maintain a pending data sink request list 32 identifying requests from PIMs 20a, 20b . . . 20n for which data sinks have been requested. The system may use rules based on the content of the print job or the requesting PIM 20a, 20b . . . 20n, pending time waiting, etc., to select a PIM when a data sink becomes available.

In one embodiment, the components, such as the PIMs 20a, 20b . . . 20n, MUX 32, interpreter/mechanism 22a and despoolers 26, 28 may execute within separate processes, where each process is allocated its own non-overlapping memory with respect to other processes and computational resources. In this way, the components may spawn additional threads to execute asynchronous operations while waiting for the MUX to respond to a request for a data sink.

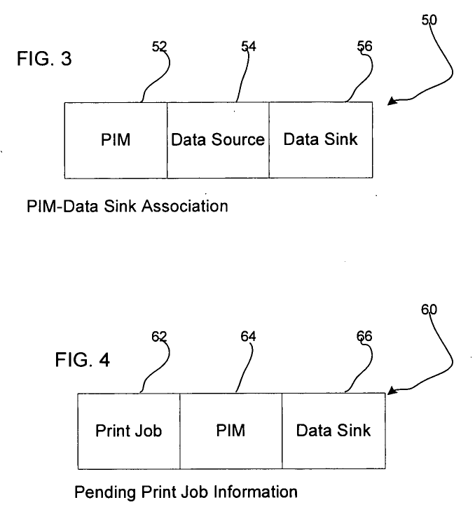

FIG. 3 illustrates an embodiment of a PIM-data sink association 50 entry in the association information 30. Each entry 50 may include a PIM identifier 52, a data source 54 indicating the client that sends jobs to that PIM, and a data sink 56 indicating the data sink 22a, 22b, 22c that receives print jobs from the PIM.

FIG. 4 illustrates an embodiment of a pending print job entry 60 in the pending data sink request list 32, including a print job 62 identifier, a PIM identifier 64 of the PIM that requested the data sink, and a data sink 66. If the MUX 14 is unable to grant the requesting PIM 20a, 20b . . . 20n access to the requested data sink 22a, 22b, 22c, then the “need data sink” return code is returned and an entry 60 created. When a data sink becomes available, the MUX 14 may apply rules to select which waiting PIM will be granted access to the available data sink. The MUX 14 rules may consider the source of the PIM, the priority of the job, and other job parameters to determine which of multiple contending requests for the same data sink to select.

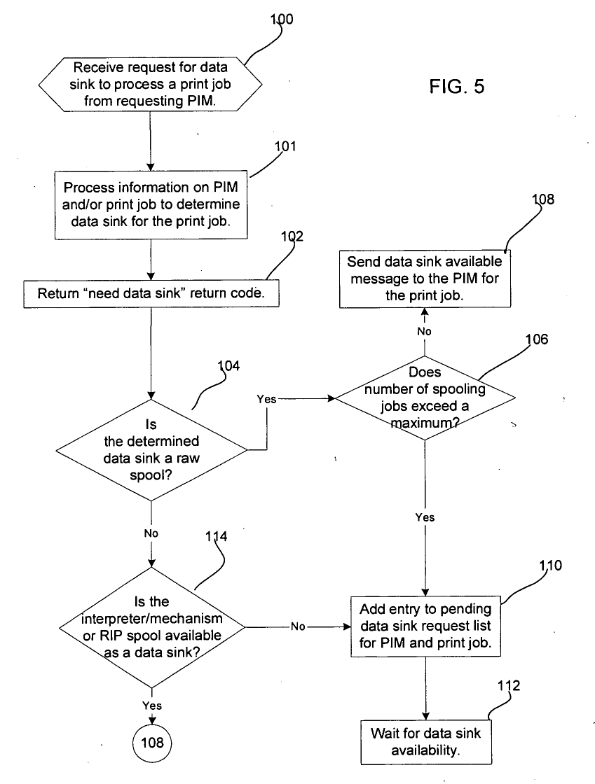

FIG. 5 illustrates an embodiment of operations performed by the MUX 14 to process a request for a data sink. In response to receiving (at block 100) a request for a data sink to process a print job from a requesting PIM, the MUX 14 processes (at block 102) information on the requesting PIM 20a, 20b . . . 20n and/or the print job to determine the data sink for the print job. In one embodiment, the MUX 14 may select the data sink 56 (FIG. 3) associated with the PIM 52 in the entry 60 for the PIM in the association of PIMs to data sinks 30. In other embodiments, the MUX 14 may process or “sniff” content of the print job to determine the appropriate data sink 22a, 22b, 22c for the print job. The MUX 14 returns (at block 101) a “need data sink” return code to the requesting PIM 20a, 20b . . . 20n.

In certain embodiments, the MUX code that returns the “need data sink” return code to the requesting PIM may comprise a MUX library routine called by the thread executing the requesting PIM. The executed MUX library routine may then communicate the data sink request to the MUX 14, which may execute on a separate process from the process executing the requesting PIM. In an alternative embodiment, the MUX 14 process may respond with the “need data sink” return code or other message.

If (at block 104) the determined data sink 20a, 20b, 20c is a raw spool 22c, then a determination is made (at block 106) as to whether the number of concurrent spooled jobs exceeds a maximum number for that data sink. If the maximum number is not exceeded, then the MUX 14 returns (at block 108) a data sink available message to the PIM 20a, 20b . . . 20n to allow the PIM to forward the print job to a next processing component. Otherwise, if the data sink (spool) is not available, then the MUX 14 adds (at block 110) an entry 60 to the pending data sink request list 32 identifying the print job 62, the requesting PIM 64 receiving the wait, and the print job 64. The MUX 14 then waits (at block 112) for the data sink to become available.

If (at block 104) the determined data sink is not a raw spool 22c, then the data sink may be an interpreter/mechanism 22a or RIP spool 22b. If (at block 114) the interpreter/mechanism 22a or RIP spool 22b is not available as a data sink, then control proceeds to block 110 et seq. Otherwise, if (at block 114) the interpreter/mechanism 22a or RIP spool 22b is available, then control proceeds to block 108 to send a data sink available message to the requesting PIM 20a, 20b . . . 20n.

In an additional embodiment, the PIM request may comprise a data sink request in an immediate form requiring an immediate response as to data sink availability. In response to such an immediate form data sink request, the MUX code may provide a return code that indicates to wait, but that a response is guaranteed soon. The MUX 14 would subsequently provide a response on whether the data sink is available. In such an embodiment, the requesting PIM waits for an immediate response to the request. The response indicates the availability of a data sink, or the rejection of the data sink request due to the unavailability of a data sink.

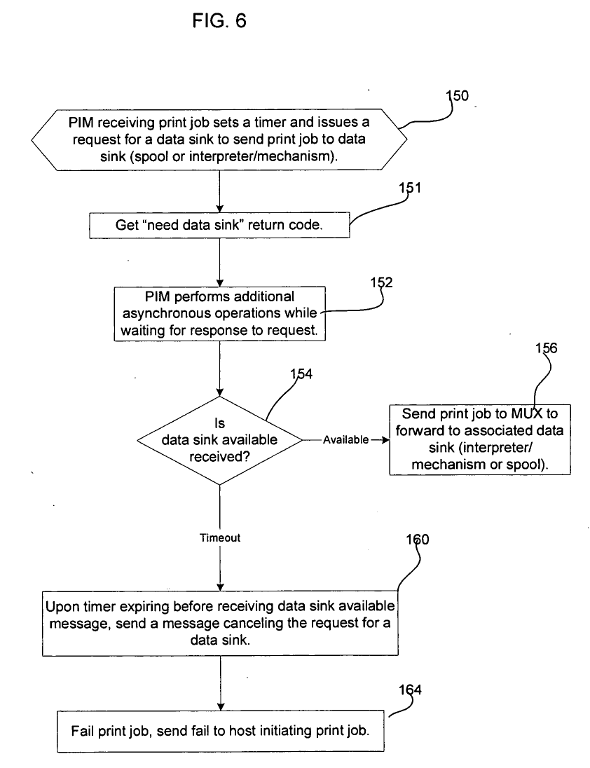

FIG. 6 illustrates an embodiment of operations performed by a PIM whose data sink is a spool 22b, 22c or an interpreter/mechanism 22a. Control begins (at block 150) with the PIM 20a, 20b . . . 20n setting a timer and requesting a data sink from the MUX 14. Upon receiving (at block 151) the “need data sink” return code from the MUX 14, which may comprise a library routine called on the PIM thread, the PIM 20a, 20b . . . 20n process may perform (at block 152) asynchronous operations while waiting for the response from the MUX 14. If (at block 154) the PIM 20a, 20b . . . 20n receives a data sink available message from the MUX 14, then the PIM 20a, 20b . . . 20n sends (at block 156) the print job to the MUX 14 to forward to the data sink, such as interpreter/mechanism 22a or raw spool 22c, associated with the requesting PIM 20a,20b . . . 20n. The PIM 20a, 20b . . . 20n may spawn additional threads to execute asynchronous and concurrent operations. If (at block 154) the data sink is not available and if (at block 160) the timer expires before receiving the data sink available message (i.e., a “timeout” occurs), then the PIM 20a, 20b . . . 20n fails (at block 164) the print job and sends fail to the host initiating the print job. The PIM 20a, 20b . . . 20n may further send a request to the MUX 14 to remove the request for the data sink from the pending data sink request list 32.

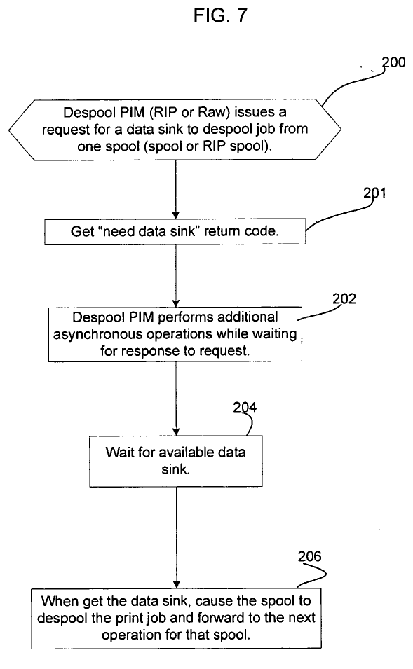

FIG. 7 illustrates an embodiment of operations performed by a RIP despool PIM 26 and raw despool PIM 28 to despool print jobs from the spools 22b and 22c, respectively. Periodically, a RIP despool PIM 26 or raw despool PIM 28 issues (at block 200) a request for a data sink to despool a print job from one spool 22a, 22c. Upon receiving (at block 201) the “need data sink” message from the MUX 14, the despool PIM 26, 28 may perform (at block 202) additional asynchronous operations while waiting for a data sink available message from the MUX 14. At block 204, the despool PIM 26, 28 waits for the data sink available message. Upon receiving the data sink available message, the despool PIM 26, 28 causes (at block 204) the spool 22b, 22c to despool the print job and forward to the next operation for that spool. In one embodiment, the RIP despool PIM 26 may send a block to the RIP spool 22b to cause the RIP despooler function in the RIP spool 22b to release a print job and forward the print job to the mechanism 6.

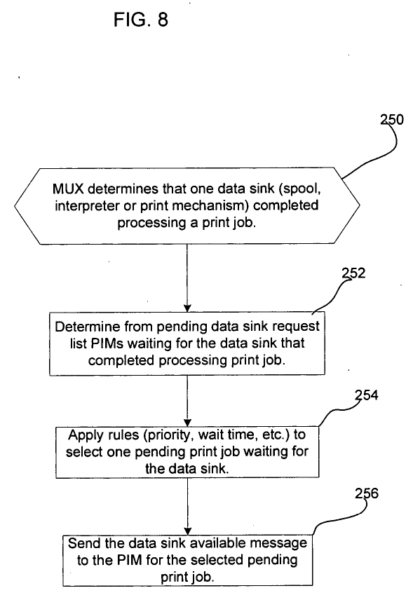

FIG. 8 illustrates an embodiment of operations performed by the MUX 14 when a data sink completes the processing of a print job. In response to determining (at block 250) that one data sink (spool 22b, 22c, interpreter/mechanism 22a or mechanism 6) completed processing a print job, the MUX 14 determines (at block 252) from the pending data sink request list 32 the identities of the PIMs 20a, 20b . . . 20n waiting for the data sink. The MUX 14 may apply (at block 254) rules (priority, wait time, etc.) to select one pending print job 60 waiting for that available data sink. The MUX 14 sends (at block 156) the data sink available message to the PIM 64 identified in the entry 60 (FIG. 4) for the selected pending print job.

A print job from a PIM receiving the print jobs from an external source that is received and immediately sent to an interpreter is subjected to the output selection process once when the job is received. A job that is spooled and then printed is subjected to the output selection process twice, once when the job is received (and spooled) and again when the job is despooled (and interpreted and printed). A RIP spool job may go through the process two or three times: first, when the job is received (RIP spool jobs are directed first to a spool); second, when the job is despooled, interpreted and directed to the RIP spool; and third when the job is despooled from the RIP spool 22b to send to the mechanism 6.

Described embodiments provide a logical printer system that allows components to engage in asynchronous operations while they are waiting to forward their print jobs to a spool or interpreter mechanism via a MUX interface. In certain embodiments, the components, such as the PIMs, MUX, interpreters, etc., may be executed by separate processes in the operating systems and have the capability to spawn multiple threads to perform asynchronous and concurrent operations. This allows PIMs to perform asynchronous operations while waiting for a response to a data sink request from the MUX.

### Additional Embodiment Details

The described operations may be implemented as a method, apparatus or article of manufacture using standard programming and/or engineering techniques to produce software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, and/or transmission signals in which code may be implemented. Of course, those skilled in the art will recognize that many modifications may be made to this configuration without departing from the scope of the present invention, and that the article of manufacture may comprise suitable information bearing medium known in the art.

Reference letters, such as 22a, 22b, 22c, 20a, 20b . . . 20n, used to denote a number of instances of an element may indicate any number of that element. Further, uses of the same reference letter in different instances with the same element or with different elements may indicate the same or different number of instances of that element.

Although FIGS. 1 and 2 illustrate a certain number of components, such as the interpreter, spool, PIMs, logical printer, etc., there may be any number of these elements in different systems.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

FIGS. 3 and 4 shows information maintained in a certain format. In alternative embodiments, the information shown in FIGS. 3 and 4 may be maintained in alternative data structures and formats, and in different combinations.

The illustrated operations of FIGS. 5, 6, 7, and 8 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. An article of manufacture including code capable of causing operations, the operations comprising:
providing a plurality of components;
providing data sinks;
receiving a request to process a print job from one of the protocol components;
determining one of the data sinks for the print job;
determining whether the determined data sink is available;
returning a return code to the component initiating the request;
returning a data sink available message to the component initiating the request in response to determining that the determined data sink is available after returning the return code; and
performing additional asynchronous operations before returning the data sink available message.

2. The article of manufacture of claim 1, wherein the components execute within separate processes, where each process is allocated its own non-overlapping memory with respect to other processes, and wherein the additional asynchronous operations are performed while waiting for the data sink available message by a thread requesting the data sink or an additional thread.

3. The article of manufacture of claim 1, wherein the operations further comprise:
setting a timer by the component when requesting the data sink;
sending, by the component, a cancellation of the request for the data sink in response to the timer expiring before receiving the data sink available message; and
returning a fail to a client initiating the print job due to the unavailability of the data sink.

4. The article of manufacture of claim 1, wherein determining the data sink for the print job comprises determining one data sink associated with the component or one data sink associated with content of the print job.

5. The article of manufacture of claim 1, wherein the component comprises a PIM, wherein the data sink comprises one of an interpreter or a spool, wherein a spool is capable of queuing multiple print jobs from at least one PIM.

6. The article of manufacture of claim 5, wherein the data sink comprises a spool, wherein the operations further comprise:
forwarding, by the PIM receiving the data sink available message, the print job to the spool;
requesting by a despooler one data sink for the spool;
determining whether the interpreter is available in response to the despooler request for one data sink; and
forwarding, by the despooler, one print job from the spool to the interpreter in response to determining that the interpreter is available.

7. The article of manufacture of claim 5, wherein the operations further comprise:
providing a Raster Image Processor (RIP) despool PIM for requesting a data sink;
determining whether the print mechanism is available in response to the request from the RIP despool PIM for one data sink; and
sending, by the RIP despool PIM, a block of data to the RIP spool to cause the RIP spool to despool at least one rasterized print job and send the at least one despooled print job to the print the mechanism in response to determining that the print mechanism is available.

8. The article of manufacture of claim 1, wherein the operations further comprise:
indicating that the print job from the component is waiting for the data sink;
determining one component waiting for the data sink in response to completing processing at least one job at the data sink; and
transmitting the data sink available message to the component waiting for the data sink that became available.

9. A system, comprising:
a printer controller;
a logical printer implemented in the printer controller, wherein the logical printer includes a plurality of components and data sinks;
code executed by the printer controller to perform operations, the operations comprising:
receiving a request to process a print job from one of the protocol components;
determining one of the data sinks for the print job;
determining whether the determined data sink is available;
returning a return code to the component initiating the request;
returning a data sink available message to the component initiating the request in response to determining that the determined data sink is available after returning the return code; and
performing additional asynchronous operations before returning the data sink available message.

10. The system of claim 9, wherein the components execute within separate processes, where each process is allocated its own non-overlapping memory with respect to other processes, and wherein the additional asynchronous operations are performed while waiting for the data sink available message by a thread requesting the data sink or an additional thread.

11. The system of claim 9, wherein the operations further comprise:
setting a timer by the component when requesting the data sink;
sending, by the component, a cancellation of the request for the data sink in response to the timer expiring before receiving the data sink available message; and
returning a fail to a client initiating the print job due to the unavailability of the data sink.

12. The system of claim 9, wherein the component comprises a PIM, wherein the data sink comprises one of an interpreter or a spool, wherein a spool is capable of queuing multiple print jobs from at least one PIM.

13. The system of claim 12, wherein the data sink comprises a spool, wherein the logical printer further includes a despooler, and wherein the operations further comprise:
forwarding, by the PIM receiving the data sink available message, the print job to the spool;
requesting by the despooler one data sink for the spool;
determining whether the interpreter is available in response to the despooler request for one data sink; and
forwarding, by the despooler, one print job from the spool to the interpreter in response to determining that the interpreter is available.

14. The system of claim 12, wherein the logical printer further includes a Raster Image Processor (RIP) despool PIM, and wherein the operations further comprise:
requesting a data sink by determining whether the print mechanism is available in response to the request from the RIP despool PIM for one data sink; and
sending, by the RIP despool PIM, a block of data to the RIP spool to cause the RIP spool to despool at least one rasterized print job and send the at least one despooled print job to the print the mechanism in response to determining that the print mechanism is available.

15. A method, comprising:
receiving a request to process a print job from one of a plurality of protocol components;
determining one of a plurality of data sinks for the print job;
determining whether the determined data sink is available;
returning a return code to the component initiating the request;
returning a data sink available message to the component initiating the request in response to determining that the determined data sink is available after returning the return code; and
performing additional asynchronous operations before returning the data sink available message.

16. The method of claim 15, wherein the components execute within separate processes, where each process is allocated its own non-overlapping memory with respect to other processes, and wherein the additional asynchronous operations are performed while waiting for the data sink available message by a thread requesting the data sink or an additional thread.

17. The method of claim 15, further comprising:
setting a timer by the component when requesting the data sink;
sending, by the component, a cancellation of the request for the data sink in response to the timer expiring before receiving the data sink available message; and
returning a fail to a client initiating the print job due to the unavailability of the data sink.

18. The method of claim 15, wherein the component comprises a PIM, wherein the data sink comprises one of an interpreter or a spool, wherein a spool is capable of queuing multiple print jobs from at least one PIM.

19. The method of claim 18, wherein the data sink comprises a spool, further comprising:
forwarding, by the PIM receiving the data sink available message, the print job to the spool;
requesting by a despooler one data sink for the spool;
determining whether the interpreter is available in response to the despooler request for one data sink; and
forwarding, by the despooler, one print job from the spool to the interpreter in response to determining that the interpreter is available.

20. The method of claim 18, wherein the operations further comprise:
requesting a data sink by a Raster Image Processor (RIP) despool PIM;
determining whether the print mechanism is available in response to the request from the RIP despool PIM for one data sink; and
sending, by the RIP despool PIM, a block of data to the RIP spool to cause the RIP spool to despool at least one rasterized print job and send the at least one despooled print job to the print the mechanism in response to determining that the print mechanism is available.
